(19) United States
(12) Patent Application Publication
(10) Pub. No.: US 2024/0058640 A1
(43) Pub. Date: Feb. 22, 2024

(54) DEVICE FOR SUPPORTING THE HEAD OF A PERSON AND COMBINATION OF A TRAINING APPARATUS AND A DEVICE FOR SUPPORTING THE HEAD OF A PERSON

(71) Applicant: Kramer Patent Holding UG, Ehingen (DE)

(72) Inventor: Michael KRAMER, Ehingen (DE)

(73) Assignee: Kramer Patent Holding UG, Ehingen (DE)

(21) Appl. No.: 18/384,622

(22) Filed: Oct. 27, 2023

Related U.S. Application Data
(63) Continuation of application No. PCT/EP2023/056042, filed on Mar. 9, 2023.

(30) Foreign Application Priority Data
Apr. 20, 2022 (DE) 10 2022 109 495.2

(51) Int. Cl. A63B 21/00; A61H 1/02

(52) U.S. Cl. CPC A63B 21/4003; A61H 1/0296

(57) ABSTRACT

A device for supporting the head of a person, having at least two lips that are placed around a first main axis and around a second main axis oriented perpendicular to the first main axis and that form, together with at least one securing system, a closed curve with a hollow space formed therein for supporting the person's head. The securing system can be designed, by matching a circumference of the curve, to form a homogeneously acting positive engagement or frictional engagement between the lips and the person's head. Also, a combination of a training apparatus and a device for supporting the head of a person is provided.

This nonprovisional application is a continuation of International Application No. PCT/EP2023/056042, which was filed on Mar. 9, 2023, and which claims priority to German Patent Application No. 10 2022 109 495.2, which was filed in Germany on Apr. 20, 2022, and which are both herein incorporated by reference.

### BACKGROUND OF THE INVENTION

### Field of the Invention

The invention relates to a device for supporting the head of a person as well as a combination of a training apparatus and a device for supporting the head of a person.

### Description of the Background Art

Training the muscles of the neck is necessary to prevent neck pain, degenerative changes of the cervical spine, and job-related neck pain (for example in jet pilots, helicopter pilots, and athletes), as well as for treatment of balance disorders, degenerative neck pain, and trauma-induced neck pain. Yet the movement of the cervical spine is extremely complex. The movement does not take place through an isolated axis, but rather in multiple planes with multiple degrees of freedom, which, moreover, change their positions relative to one another during a head movement. Physiological head rotation is thus composed of the sum of a combination—which changes during the movement—of rotation, lateral flexion, and flexion/extension components of each individual vertebral body of the cervical spine.

For effective and safe training while avoiding undesirable transmission of force to the delicate structures of the cervical spine of the trainee, it is important to be able to fix the position of the trainee's head as precisely as possible. The device for supporting the head should allow a transmission of force between the person's head and the training apparatus, but without triggering undesirable applications of force to the cervical spine.

It is also important for surgical navigation with a computer-assisted referencing device, such as is described in DE 197 51 761 A1, or for intraoperative imaging in a CT or MRI to fix and to know the position of the head as precisely as possible, and to be able to accurately detect changes in the position. It is known for this purpose to use structural bodies, known as navigation stars, with rods arranged in a characteristic manner whose angular arrangement and tilt permits an exact position analysis of precisely these structural bodies, from which the position of the head can then be deduced. It is therefore important to precisely fix and to retain the position of the structural bodies relative to the head. For the purpose of position fixing, Black Forest Medical Group provides skull clamps under the Doro brand, for example, which have three pointed pins for penetrating the osseous structure of the skull, although this is disadvantageous with juvenile patients because their bones are still insufficiently hard. The device for supporting the head can likewise be used for fixing the position of the head.

For this purpose, the device for supporting the head must be matched to the size and the shape of the head in order to prevent tilting or slipping of the device relative to the head. Head shapes and head sizes can differ considerably, however. At the same time, the device for supporting the head should satisfy the abovementioned conditions for as many trainees or patients as possible in order to make an application usable for a multiplicity of different persons with different head shapes and sizes. Furthermore, the device for supporting a head for use in combination with a training apparatus should allow transmission of forces during rotational movements and tilting movements in all physiologically possible individual directions and combined movements.

### SUMMARY OF THE INVENTION

It is therefore an object of the present invention to provide a device for supporting a head, and a combination of a training apparatus and a device for supporting a head, that reduce the abovementioned disadvantages.

In an example, the device for supporting the head of a person is provides that at least two lips are present that are placed around a first main axis and around a second main axis oriented perpendicular or substantially perpendicular to the first main axis and that form, together with at least one securing system, a closed curve with a hollow space formed therein for supporting the person's head. The securing system in this case is configured by matching a circumference of the curve, thus forming a positive engagement or frictional engagement, in particular a homogeneously acting positive engagement or frictional engagement, between the lips and the person's head. A gentle, largely or completely equalizing clamping of the head is thus accomplished by the device for supporting the head with the associated lips, without the need to invasively compromise the head.

The device for supporting a head can be designed in one piece with a structural body for surgical navigation or be a permanent component of a training apparatus. It is more advantageous when at least one coupling element is provided for coupling to a structural body and/or to a training apparatus for the purpose of attachment.

The securing system can be formed as a band, for example, as a flexible band, such as a headband. Alternatively, the securing system can also be formed as elastic or cables or wire cables. This permits a transmission of force between the training apparatus and the device, and thus a transmission of force from the training apparatus through the device to the person's head, with no slipping or tilting of the device occurring relative to the head. Also, the device makes it possible to prevent local pressure peaks on the head or on the neck muscles in that the fit between device and head is optimally matched via the positive engagement, regardless of the shape or size of the head, and consequently a homogeneous distribution of pressure occurs over the circumference of the head. The securing system can be connected to the coupling elements.

In this context, it is advantageous when the closed curve forms an ellipse, wherein the deviation of the length of the main axes from one another corresponds to less than 25%, preferably less than 15%, especially preferably less than 10%, and very especially preferably less than 5%. It is very especially preferred when the lengths of the main axes agree with one another, which is to say when the curve forms a circle.

In the simplest case, the securing system is formed as a band or as a headband so that a force is transmitted to the grippers by the elastic design of the band. The securing system additionally can include at least one tension and/or compression component for adjusting a circumference of the closed curve. A change in the circumference of the closed curve of the securing system brought about by the tension and/or compression component causes an application of force to the lips. The tension and/or compression component in this case can be formed as a twist-lock closure, a BOA closure, or a latching closure. The securing system can also be formed as a latch in cooperation with the latching closure. The tension and/or compression component can also be a sleeve that is connected to the securing system and is movable along a rod in such a manner that the circumference of the curve of the securing system is adjusted. In order to be able to match the device even better to the size and shape of the person's head, it is preferred when a multiplicity of tension and/or compression component are present and in particular when they are uniformly distributed over the circumference of the curve/of the securing system.

The possibility exists that at least two curved rods, which are connected to one another at their free ends so as to be adjustable in length, are associated with the securing system. These rods can function as a rigid outer element on which the tension and/or compression component, in particular a wire of the BOA closure, is guided in order to prevent its contact with the head or incorrect interaction with the lips. It is then advantageous when the connection is formed at least at one pair of the free ends by a threaded rod with opposite-direction threads at its ends, which engage in a spindling manner with the free ends in threaded receptacles having a corresponding thread direction, since an adjustment of the rigid outer element to the width of the head can take place in this way. Alternatively, this can also be accomplished through any type of telescoping axis.

The lips can be formed as grippers that are connected to the securing system, wherein each of the grippers has two curved, mutually converging, outer sidewalls that are connected to one another by struts and that are in operative connection with one another in such a manner that a force exerted on at least one of the outer sidewalls in a direction of force causes a deflection of the gripper opposite the direction of force to create a positive engagement or frictional engagement between the grippers and the person's head. It is possible via the grippers to create a homogeneous positive engagement or frictional engagement between the grippers, which is to say between the device and the person's head. The grippers are finlike, so that when a force acts on one side of the outer sidewall, the ends of the stressed outer sidewall deflect opposite the direction of action of the force. The outside surfaces are flexible, but made to retain their shape, and can be made as a single piece. In particular, the grippers may be manufactured by an additive manufacturing process, in particular by 3D printing. Consequently, if pressure is exerted on the outer sidewall in one place, then the region yields where the highest force per area is exerted. At the same time, the blunt end and the pointed end are deflected opposite the direction of pressure. As a result, a recess is produced, with the blunt end and the pointed end of the gripper executing a movement opposite the direction of pressure. This permits a positive engagement between the head and the gripper, thus allowing the device to adjust to every individual head shape and head size via the grippers. The grippers can be made of plastics, in particular of polypropylene (PP), polyethylene (PE), or of thermoplastic polymers (TPU) or polyamides such as PA6, PA11, or PA12. The securing system can be made as a single piece or also as multiple pieces, which is to say the securing system can form a closed curve or the securing system can, for example, form a closed curve with the grippers by attachment thereto. The outer sidewalls of the gripper can be arranged on an inside surface of the securing system. Parts of the gripper can also be arranged on an outside surface of the securing system, however. The outer sidewalls of the gripper taper to a point on one side, and they form a blunt end on the opposite side. The struts inherently have different lengths to permit a curved shape of the gripper. A homogeneous distribution of the contact pressure on the surface of the head is possible due to the homogeneous positive engagement or frictional engagement. At the same time, the contact surface between the device, in particular between the outer sidewalls of the gripper, and the head is comparatively large, so that an optimal transmission of force between the device and the person's head, which is to say between the training apparatus and the person's head, is ensured. Furthermore, in order to permit an even more homogeneous distribution of the contact pressure, it is preferred when there are a multiplicity of grippers, in particular when they are arranged and distributed regularly around the circumference, and connected to the securing system.

For better transmission of force between the outer sidewalls of the gripper and the head, the struts of the grippers can be formed from a convexity with one or two rods connected to the convexity.

In order to permit a homogeneous distribution of the contact pressure, the grippers can be arranged opposite one another and are connected to the securing system for contact of the first gripper on a forehead and for contact of the second gripper on a back of the head. Particularly in order to enlarge the contact surface between the grippers and the head, it is preferred when a multiplicity of first grippers, in particular at least two grippers (which can be arranged side by side), and a multiplicity of second grippers (at least two, preferably four or more) are present. The grippers can be connected to the same securing system or to different securing system.

In order to prevent a strain on the neck muscles, the second gripper can be designed for contact above the external occipital protuberance of a head.

In this context, it is also advantageous for reducing strain on the neck muscles when the coupling elements are oriented such that a coupling axis running between the coupling elements and a training apparatus corresponds or approximately corresponds to an auditory canal axis running between the auditory canals of a head.

Furthermore, it is advantageous when at least one of the grippers is composed of a multiplicity of subgrippers, wherein two of the subgrippers are connected to one another by at least one flexible connecting strut.

Alternatively, it is advantageous when the lips are formed in a wave shape having a minimum of one wave crest and one wave trough, and when at least one of the wave crests are connected to the securing system. The wave troughs form predetermined bending points in this design, so that when there is an application of force owing to adjustment—in particular reduction—of the circumference of the curve, a bending of the predetermined bending point(s) is achieved, and consequently a positive engagement or frictional engagement between the lips and the person's head. The height of the wave crests can decrease with increasing distance from the respective coupling element in this design. The wave crests can have tunnels or tabs for connection to the securing system in this design. Padding can be arranged between the lip and the person's head in order to improve wearing comfort of the device. The padding can be made as a single piece or as multiple pieces.

Further, every lip in the region of the coupling element can have a first thickness or a first thickness range, and the lip in the region adjacent to the first region can have a second thickness or a second thickness range, wherein the second thickness can be smaller than the first thickness, or the second thickness range can be smaller than the first thickness range. The thickness ranges may not overlap in this case. For example, the thickness of the lip can decrease at least in sections with increasing distance from the first region. The thinner the lip, the more flexible the lip is as well, so that when force is applied in the region where the head has the strongest curvature, the lip also curves most strongly, or in other words can adjust best in order to create a positive engagement or a frictional engagement.

In order to be able to better fix the position of the device relative to the person's head, it is advantageous when the coupling elements are connected indirectly or directly to a strap for contact with the person's chin. The two coupling elements can therefore be connected by a strap, which rests against the person's chin. The strap in this case can be designed to be adjustable in length, in particular can have an additional tension and/or compression component in order to be able to adjust the length of the strap to the length of the distance between the coupling elements and the chin.

In order to permit a snug fit of the device on the head, an ear cup can be provided in each case to surround an associated ear, for example, to surround the ear completely. The ear cup can be designed to be stiff, but can have padding such as silicone on the inside surface. The ear cup can also be made flexible in order to make it possible to surround the ear or ears of different sizes.

Each curved rod can be composed of two sub-rods whose ends that face one another are associated with one of the ear cups. The coupling element can be formed on the ear cup and/or the sub-rods.

Furthermore, a plurality of securing system can be provided that are arranged so as to be spaced apart from one another and are each connected to at least one lip. In this context, the securing system can also have different circumferences so that the securing system can be arranged in different places along the head, which is to say in places with a smaller diameter or with a larger diameter. The securing system can be coupled by an additional connector, wherein this connector can be designed for contact with the back of a person's head and/or for contact with the person's forehead.

The combination of a training apparatus and a device for supporting a head is characterized, for example, in that the device can be coupled or is coupled to the training apparatus via the coupling elements. The training apparatus preferably serves here to reproduce natural movements of the cervical spine, and permits free mobility of the cervical spine in all degrees of freedom for a physiologically desirable mobility. The advantages and examples mentioned with regard to the device can also be transferred or applied to the combination that includes the device.

In order to permit the head to be optimally fixed in the device and at the same time to permit a transmission of force from the head to the training apparatus, it is preferred when the training apparatus can be coupled to the ear cups via a connecting element in such a manner that a coupling axis running along the connecting elements coincides or approximately coincides with an auditory canal axis running between the auditory canals. Via the device according to the invention, it is ensured that the auditory canal axis and the coupling axis continue to coincide even when there is an adjustment of the device to the head shape. Optionally, the device, in particular the coupling elements, can additionally have springs for centering the three axes of rotation.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a top view of an example of the device,

FIG. 2 is a profile view of the device from FIG. 1, attached to a head,

FIG. 3 is a front view of the device from FIG. 2,

FIG. 4 a top view of an example of the device,

FIG. 5 is a top view of an example of the device,

FIG. 6 is a top view of an example of the device,

FIG. 7 is a top view of the combination of a training apparatus with the device,

FIG. 8 is a front view of a training apparatus,

FIG. 9 is a detail view of the cross slide,

FIG. 10 is a detail view of the training mechanism,

FIG. 11 is a rear view of a part of the frame and of the training mechanism of the training apparatus,

FIG. 12 is a detail view of the rear view with the length compensator and the training resistances,

FIG. 13 shows an example for creating the training resistance,

FIG. 14 shows an example for creating the training resistance,

FIG. 15 is a perspective representation of an example of the device with a rigid outer element,

FIG. 16 is a view from the right of the device from FIG. 15,

FIG. 17 is a top view of the device from FIG. 15,

FIG. 18 is a top view of the isolated outer element of the device from FIG. 15,

FIG. 19 is a top view of isolated securing system with the tensioner and the grippers, and

FIG. 20 is a perspective representation of the device from FIG. 15 clamping a head.

### DETAILED DESCRIPTION

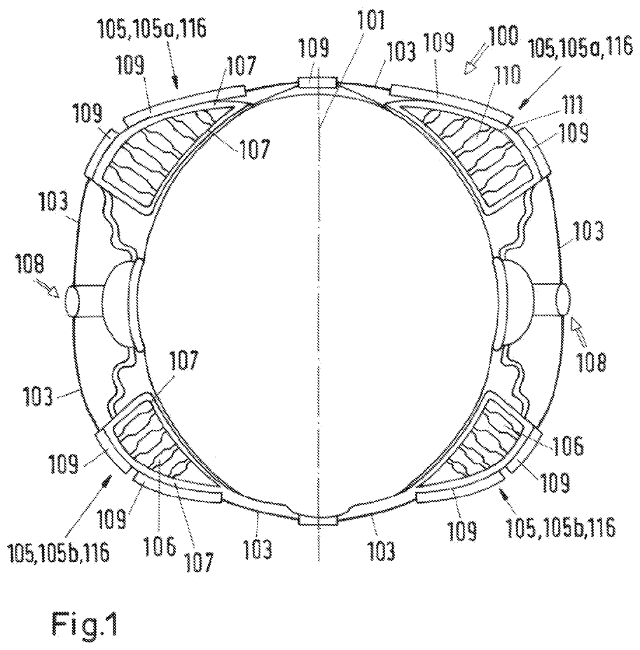

FIG. 1 shows a top view of an example of a device 100 for supporting the head of a person, having at least two lips 116 that are placed around a first main axis 101 and around a second main axis 102 oriented perpendicular to the first main axis 101 and that form a closed curve with at least one securing system 103. The curve forms a hollow space in which the person's head can be supported. The securing system 103 includes at least one tension and/or compression component 108, in the present case multiple tension and/or compression component 108, for adjusting a circumference of the closed curve of the securing system 103. In the illustrated example, the securing system 103 includes a BOA closure with a BOA dial and BOA cords as tension and/or compression component 108. In a simple case, the securing system 103 can also be formed as a band, in particular an elastic band such as a headband, or as latch, wherein the tension and/or compression component 108 is then formed as a latching closure.

In the case of the device 100 according to FIGS. 1 to 3, the lips 116 are formed as grippers 105, which are connected to the securing system 103. Each of the grippers 105 has two curved, mutually converging, outer sidewalls 107 that are connected to one another by struts 106 and that are in operative connection with one another in such a manner that a force exerted on at least one of the outer sidewalls 107 in a direction of force causes a deflection of the gripper 105 opposite the direction of force to create a positive engagement or frictional engagement, in particular a homogeneous positive engagement or frictional engagement, between the grippers 105 and the person's head. The closed curve of the securing system 103 can form an ellipse, wherein the deviation of the length of the main axes 101, 102 from one another corresponds to less than 25%, preferably less than 15%, especially preferably less than 10% and very especially preferably less than 5%. Further, the closed curve can form a circle, which is to say the lengths of the main axes 101, 102 are identical to one another. This permits a homogeneous distribution of the contact pressure on the person's head.

If a change in the circumference of the securing system 103 is caused by the tension and/or compression component 108, then this force is transmitted to the outer sidewalls 107 of the gripper 105 to create a positive engagement or frictional engagement between the person's head and the outer sidewalls 107 of the gripper 105. The tension and/or compression component 108 are arranged at regular intervals from one another along the curve of the securing system 103 in this case. In particular, the tension and/or compression component 108 can be arranged between the grippers 105, in particular in the region of the coupling elements 104. Moreover, an additional tension and/or compression component 108 can also be arranged in such a manner that it is designed to contact a back of the person's head. For the purpose of connecting the grippers 105 to the securing system 103, the grippers 105 are implemented on an external outer sidewall 107 with a guide tube 109 in which the securing system 103 is guided. In the present case, the guide tube 109 is made as multiple pieces, which serves to simplify manufacture. In order to make possible an optimal application of force and also a decoupling of the force between the grippers 105 and the head, the struts 106 of the grippers 105 can be formed from a convexity 110 with one or two rods 111 connected to the convexity 110, when the struts 106 have a part with a first diameter and at least one second part with a diameter that is smaller than the first diameter.

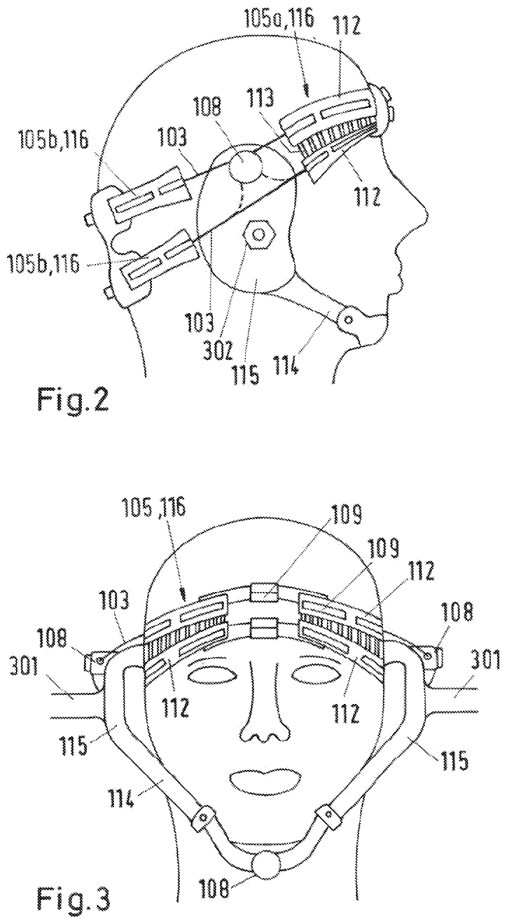

FIG. 2 shows that a multiplicity of securing system 103 are provided that are arranged so as to be spaced apart from one another and are each connected to at least one gripper 105. In addition, it is evident from FIG. 2 that the securing system 103 can be coupled together at the back of the head via an additional connector. This prevents a shifting of the securing system 103 relative to one another. It can furthermore be seen in FIG. 2 that the grippers 105 are arranged opposite one another, and are connected to the securing system 103 for contact of the first gripper 105a on a forehead of the head and contact of the second gripper 105b on a back of the head. In the present case, a multiplicity of first grippers 105a and a multiplicity of second grippers 105b are provided. The first grippers 105a are spaced apart from one another in this arrangement. The device 100 can have two first grippers 105a and four second grippers 105b. The second grippers 105b are designed here such that they make contact above the external occipital protuberance of the head. This prevents a strain on the neck muscles. In addition, it is evident from FIG. 2 and FIG. 3 that the grippers 105 can be composed of a multiplicity of subgrippers 112, wherein two of the subgrippers 112 are connected to one another by flexible connecting struts 113. This enlarges the contact surface of the grippers on the forehead and thus on the person's head. The connecting struts simplify the relative positioning of the subgrippers.

It is furthermore evident from FIG. 2 that the coupling element 104 is formed as a rigid ear cup 115 to surround the ear. The tension and/or compression component, which is to say the BOA closure, in particular the dial of the BOA closure, is also associated with the ear cup 115, in particular implemented thereon. Furthermore, the ear cup 115 is connected to a strap 114, which is designed for contact with a chin. This makes it possible to secure the device on the head even better. It is evident from FIG. 3 that the strap is also designed to be adjustable in length and another BOA closure, which is to say an additional tension and/or compression component 108, is also present for adjusting the length.

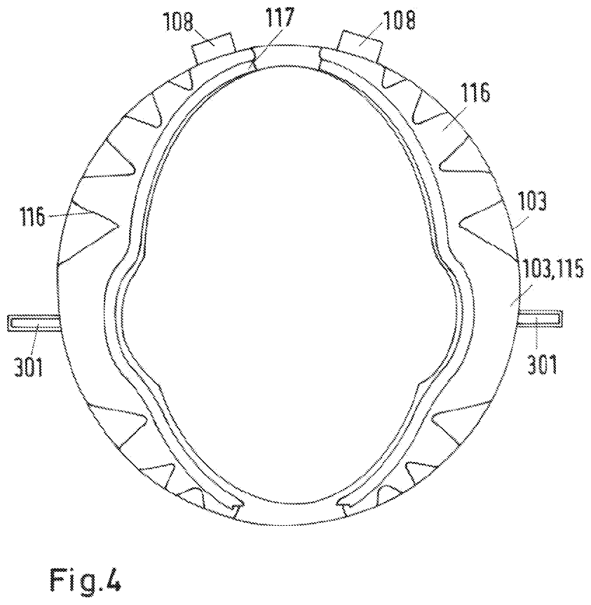

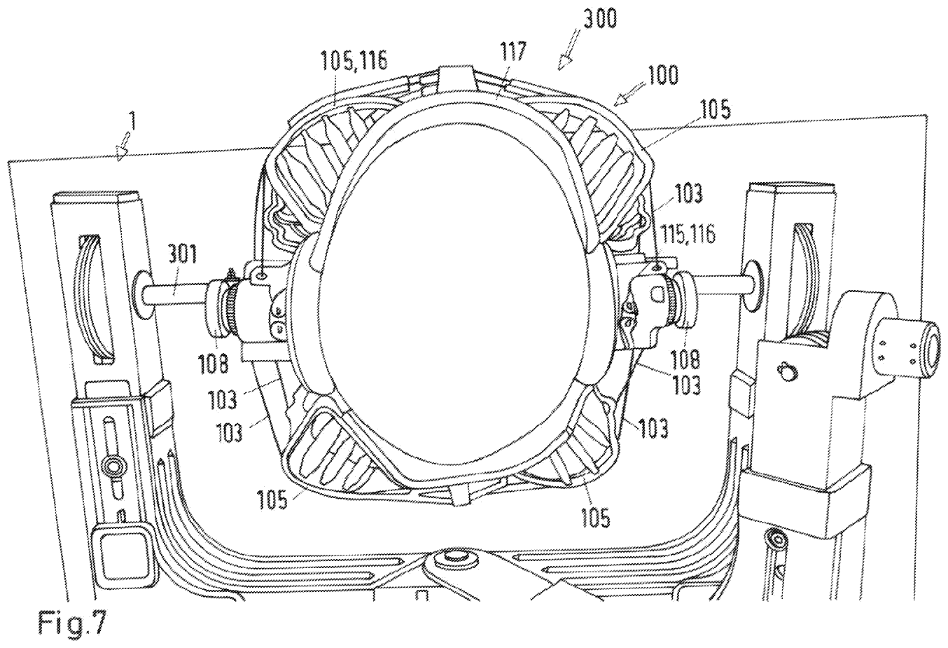

Present on the ear cups 115 is a coupling surface 302, at which the device 100 can be coupled to a training apparatus 1. This is clear from FIG. 7, which shows a combination of a part of the training apparatus 1 and the device 100 for supporting the head. FIG. 7 shows a combination 300 with the device 100, wherein the other examples of the device shown in FIGS. 4 to 6 naturally also can be coupled/are coupled to the training apparatus 1. The ear cup 115 is connected to the training apparatus 1 at the coupling surface 302 via a connecting element 301 in such a manner that a coupling axis running along the connecting elements 301 coincides with an auditory canal axis running between the auditory canals of the person's head.

FIG. 4 shows a second example of the device 100, in which the lips 116 can be formed in a wave shape having a multiplicity of wave crests and wave troughs. The wave troughs in this design form predetermined bending points. In the event of an adjustment, in particular a reduction, of the circumference of the curve, the application of force to the lip 116 thus induced achieves a bending of the predetermined bending points and consequently a positive engagement or frictional engagement between the lips 116 and the person's head. The height of the wave crests preferably decreases with increasing distance from the respective coupling element 104 in this design. Padding 117 is arranged between the lip 116 and the person's head in this design in order to improve wearing comfort of the device. The padding 117 can be made as a single piece or as multiple pieces. The securing system is placed around the lips 116 as a closed curve and connected to the wave crests, for example by tabs or tunnels formed on the wave crests. The circumference of the closed curve of the securing system 103 can be adjusted using the tension and/or compression component 108, as a result of which an application of force to the wave crests of the lips takes place and they bend at the predetermined bending points in order to form a positive engagement, in particular a homogeneously acting positive engagement or frictional engagement with a concentric pressure with the person's head. The lip 116 is connected to the coupling elements 104, in particular to the coupling elements 104 formed as ear cups 115.

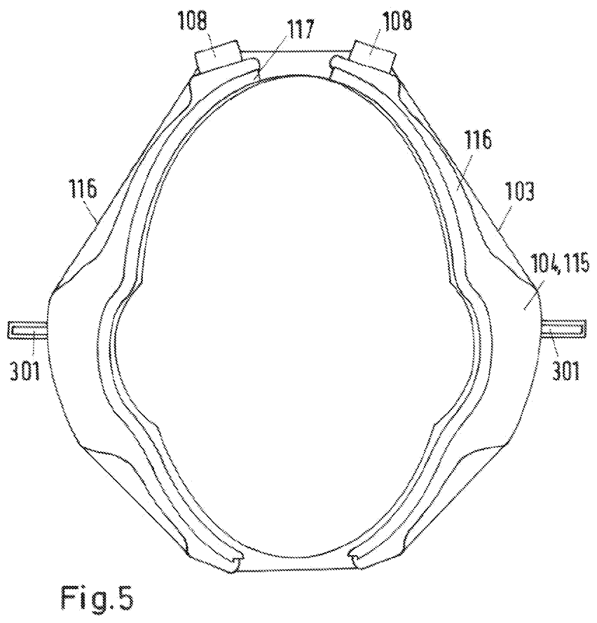

FIG. 5 shows an example of the device 100, in that every lip 116 in the region of the coupling element 104 can have a first thickness or a first thickness range. In the region adjacent to the first region, the lip 116 has a second thickness or a second thickness range, wherein the second thickness is smaller than the first thickness, or the second thickness range is smaller than the first thickness range. The thickness ranges of the first region and of the region adjacent to the first region preferably do not overlap in this case. Owing to the decreasing thickness of the lips, they become more flexible in the regions where the greatest adjustment of the device 100/lip 116 to the person's head must occur so that a positive engagement or frictional engagement is formed between the lip and the person's head. In addition, it is evident from FIG. 5 that the thickness of the lip decreases at least in sections with increasing distance from the first region. The securing system is made as multiple pieces and includes a tension and/or compression component 108 formed as a BOA closure, which can rest against the back of the person's head. The securing system formed as a band or wire or cable is connected to the lip 116 in the vicinity of the first and second main axes 101, 102. Padding 117 is arranged between the lip 116 and the person's head in this design in order to improve wearing comfort of the device. The padding 117 can be made as a single piece or as multiple pieces.

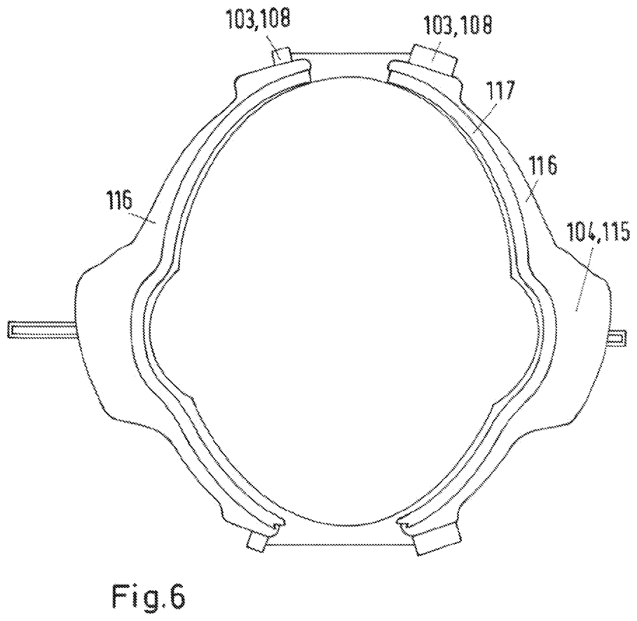

FIG. 6 shows an example of the device 100, in that the lips 116 can be connected to one another at the ends by one tension and/or compression component each. The securing system 103 is consequently formed as tension and/or compression component 108, for example, as a BOA closure with a BOA cable. The tension and/or compression component 108 can be made for contact with the forehead and the back of the person's head. The lip can be connected to the tension and/or compression component 108 by tabs or tunnels implemented on the lips at the ends. Padding 117 is arranged between the lip 116 and the person's head in this design in order to improve wearing comfort of the device. The padding 117 can be made as a single piece or as multiple pieces.

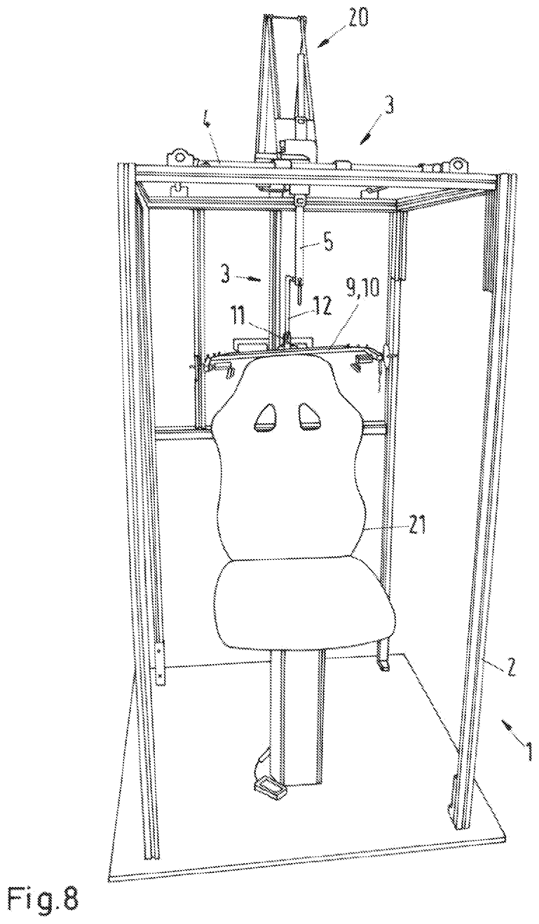

FIG. 8 shows a training apparatus 1 for training the muscles of the neck, which has a frame 2 and, mounted on the frame 2, a training mechanism 3 that can be coupled to the device 100 (not shown in detail) for supporting the head of a person. The device may have a seat 21 or even a chair so that the trainee trains while seated. In a simple example, merely a seating surface or a stool can also be provided. Furthermore, it likewise is alternatively possible for the trainee to train while standing or kneeling.

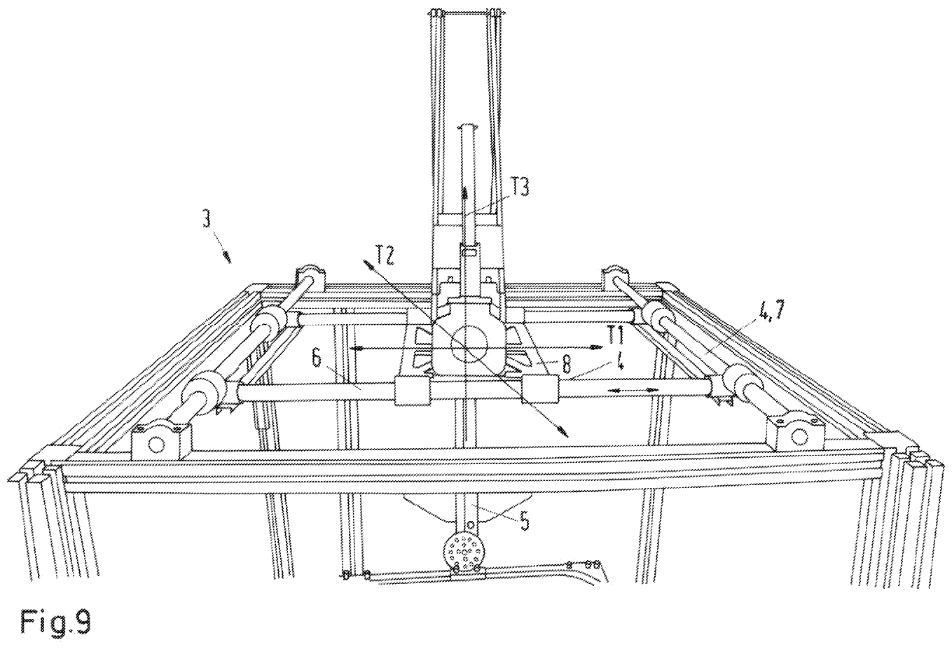

The training mechanism 3 includes a cross slide 4, which is shown in detail in FIG. 9. The cross slide 4 in this case has a first slide 6 and a second slide 7 that is arranged orthogonally to the first slide 6 and is movable on the first slide 6. A cross member 8 is movably arranged on the first slide 6 so that the cross member 8 is movable along a first translational axis T1 on the first slide 6, and is additionally movable along a second translational axis T2, which is orthogonal to the first translational axis T1, via the motion of the first slide 6 on the second slide 7. In the present case, the two slides 6, 7 and the cross member 8 are arranged in one plane. It is also possible, however, to arrange the slides 6, 7 above or below one another. A rail 5 carried in a guide is mounted at the center of the cross member 8 so as to be rotatable about a first of the rotational axes. In addition, the rail 5 is carried in the guide so as to be adjustable in height, allowing an up-and-down motion of the coupling element, which is to say a translational motion along a third translational axis T3. In the present case, the rail 5 is arranged at the center with respect to the cross member 8 and at the center with respect to the coupling element or the trainee's head. In this way, a motion of the trainee's head or of the coupling element to the right and to the left is made possible so that the first rotational axis R1 corresponds to the anatomical axis of rotation of the cervical spine.

The rail 5 and/or the guide furthermore carry a framework 9, which provides a second rotational axis R2 and a third rotational axis R3. For this purpose, the free arm of the rail 5 is connected by a connecting piece 12 that can be angled at 90° to a U-piece 10 that is guided at least partially around the coupling element. The U-piece 10 extends horizontally at the height of the trainee's cervical spine. The free end of the connecting piece 12 is connected via a rotary joint 11 to the U-piece 10 in this case so that a rotary motion is made possible about the second rotational axis R2, which is orthogonal to the first rotational axis R1.

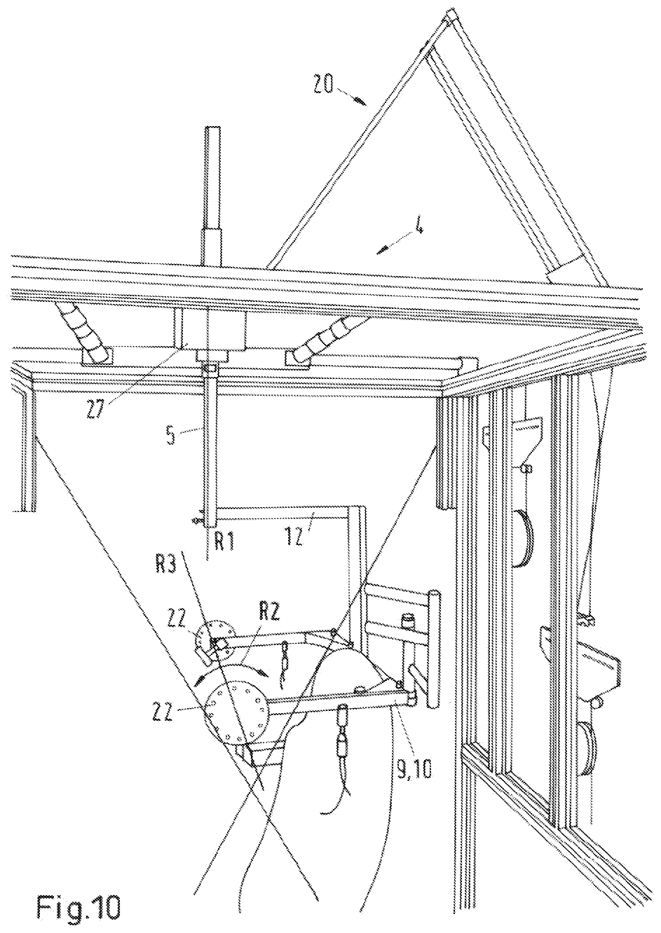

Arranged on each of the free arms of the U-piece 10, as is evident from FIG. 10, is an additional rotary joint 22 or a rotary disk, by which means the U-piece 10 can be coupled to the coupling element 104, for example, at the height of an auditory canal of the trainee. A rotation of the coupling element 104, i.e. of the trainee's head about the third rotational axis R3, which in turn is orthogonal to the other rotational axes R1, R2, is consequently made possible via this additional rotary joint 22. As a result of this arrangement, it is possible for the coupling element 103 to be rotatable about the three rotational axes R1, R2, R3 and translatable along three translational axes T1, T2, T3 via the training mechanism 3. Furthermore, the rotational axes R1, R2, R3 consequently have a common point of intersection, which is located in the region of the trainee's cervical spine, for example at the center point of the base of the trainee's dens axis. This prevents injuries or improper training and, moreover, simulates the natural movement of the head or the neck muscles consisting of flexion/extension/rotation and lateral flexion movements.

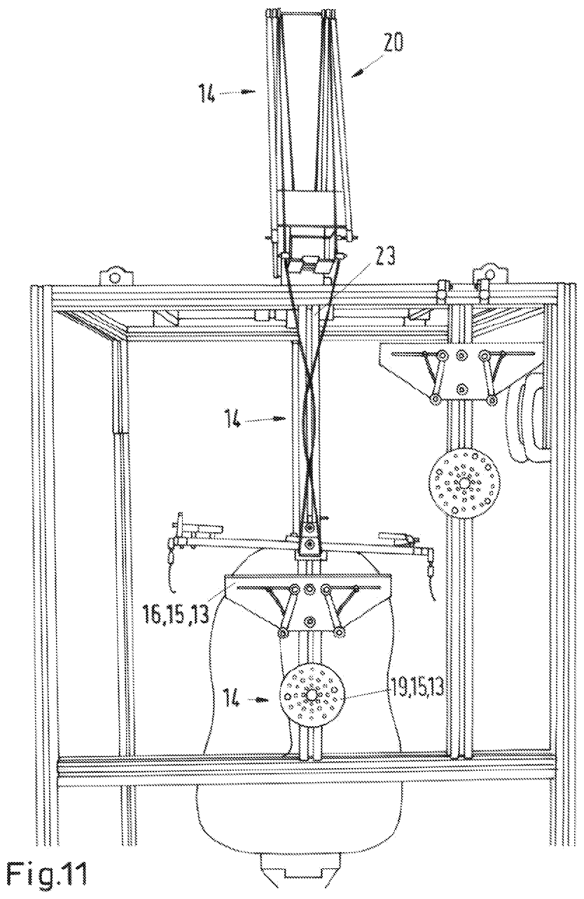

The neck muscles can be trained via a training resistance 13. For this purpose, the training apparatus 1 has at least one training resistance 13, which can be formed, for example, as a spring or as a weight. In the present case, the training resistance 13 is formed as a weight, namely as a disk 19 and as a plate 16, in the present case as a trapezoidal plate, as shown in detail in FIG. 11. The plate 16 and the disk 19 are movably mounted on an additional rail 23 outside of the cross slide 4. The additional rail 23 in this case is arranged on a rear wall of the frame, which is to say behind the coupling element or behind the trainee. It is also evident from FIG. 11 that the frame can also have a second or even more additional rails 23, on which an additional plate 16 and/or an additional disk 19 is movably mounted. The number of training resistances 13 is increased by this means.

In order to adjust the force transmitted to the coupling element as a function of the angular position of the coupling element 103, the weight of the training resistances 13 is transmitted to the coupling element via a cable control 14. In the present case, the training resistances 13 are simultaneously also formed as a length compensator 15, through which the cable control 14 is guided in such a manner that the length of the cable control 14, and thus the force transmitted to the coupling element via the training resistances 13, is adjusted as a function of the translational motion and/or the rotational motion. Formed on the outer circumferential side of the disk 19 is a groove around which the cable control 14 is guided to the trapezoidal plate 16.

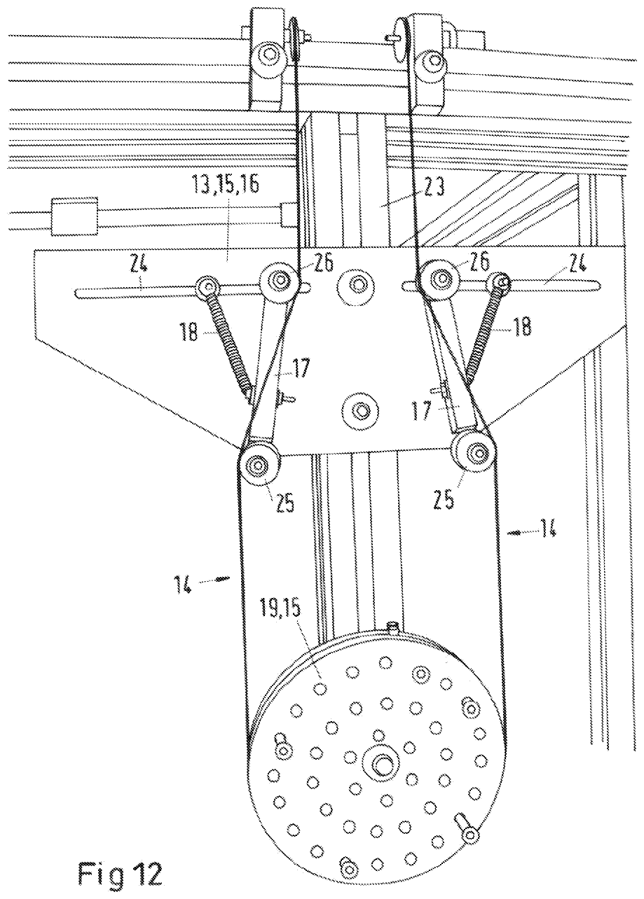

The trapezoidal plate 16 in this case has, as is evident in detail from FIG. 12 in particular, two cable guides 17, each of which is movably guided in a support 24, which is formed to the side of the axis of symmetry of the trapezoidal plate 16. The support 24 in this case is formed as an elongated hole that extends parallel to the longer base of the trapezoidal plate 16. At their respective ends, the cable guides 17 have pulleys 25, 26, on which a groove can be formed on the outer circumferential side. The cable of the cable control 14 is guided from the outside surface of the first pulley 25, which is not arranged in the support 24, to the inside surface of the second pulley 26. Owing to the mounting of the cable guides 17 in the respective support 24, the cable guide 17 is pivotably mounted. The first pulleys 25 are pivotably mounted on the plate 16. Also arranged in each support 24 is an elastic spring 18 that is connected to the cable guide 17 and that likewise is movable in the support and, in the present case, can be fixed therein via a screw. This permits a preloading of the cable guide 17 via the spring 18. A length compensation of the cable control 14 as a function of the rotational motion and the translational motion is therefore possible via the movable and preloadable cable guide 17.

The disk 19 can also be made elliptical, or can be guided with a lateral offset instead of being guided at its center point on the additional rail 23, so that turning the disk 19 results in an elliptical movement. This likewise leads to a length compensation in the cable control 14. The length compensation results here in a physiological force curve so that the force of the training resistances 13 transmitted to the coupling element 104 changes as a function of the angle of motion.

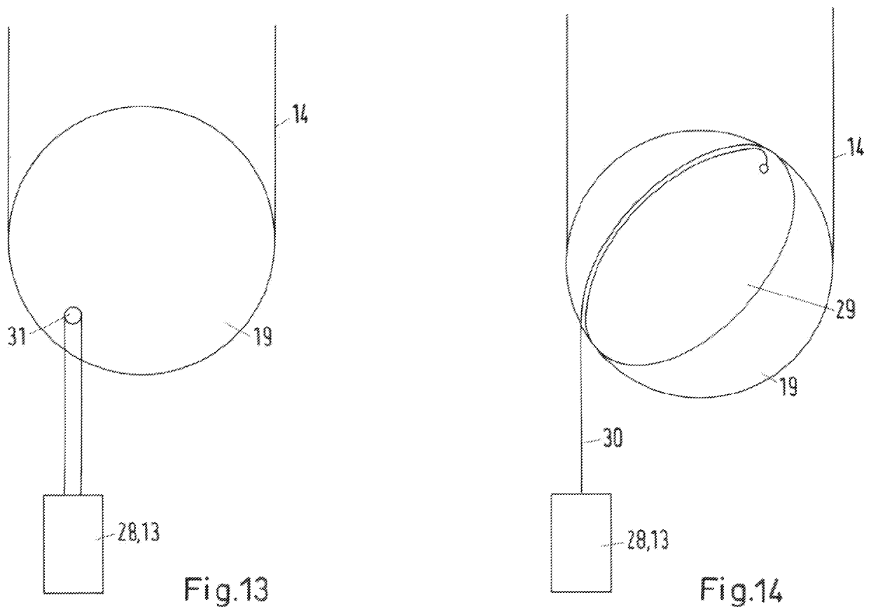

FIG. 13 shows an example for creating the training resistance 13. The training resistance 13 is created by a resistance 28, in the present case a weight, one end of which is attached eccentrically to the disk 19 via a pin 27. To vary the training resistance 13, the pin 27 can also be inserted in pin receptacles with different positions in the disk 19. The weight 28 is moved opposite the force of gravity by rotation of the disk 19, thereby creating a resistance. The angular range of the training movement can correspond here to a rotation of the disk 19 by less than 180°. The change in height of the resistance 28 approximately corresponds here to the sine of the change in angle of the disk 19, which in turn approximately corresponds to a force curve that is advantageous for physiological training. The resistance 28 can be formed here as a weight or as a spring or as a rubber band or as a hydraulic system or the like.

FIG. 14 shows an example for creating the training resistance. Attached to the round disk 19 is a noncircular disk 29, in the present case an elliptical disk 29, with a groove formed on the outer circumferential side, through which is guided an additional cable control 30 whose top end is attached to the noncircular disk 29. Attached to the bottom end of the additional cable control 30 is a resistance 28, in the present case a weight, which is moved opposite the force of gravity upon a rotation of the disk 19. It is an advantage that the curve of the change in height of the weight 28 with respect to a floor can be determined through the change in angle and the angular position of the disks 19, 29 and by the outer (noncircular) shape of the noncircular disk 29. Differently shaped noncircular disks 29 thus create different force-angle curves.

In order to achieve a change in length and a motion of the cable control 14 upon rotational motions, but not upon translational motions, of the coupling element, a tapering bridge structure 20 is arranged on one side of the cross slide 4, namely on the top of the frame 2, which is to say on the side of the frame 2 facing away from the floor, the two elements of which bridge structure are articulated to one another, by which means the cable control 14 is guided, in particular over guide pulleys. The cable control 14 in this design is guided from the plate 16, over the bridge structure 20, around an idler pulley 27 formed on the cross member 8. The idler pulley 27 in this design is arranged on a rotary joint between the cross member 8 and the rail 5.

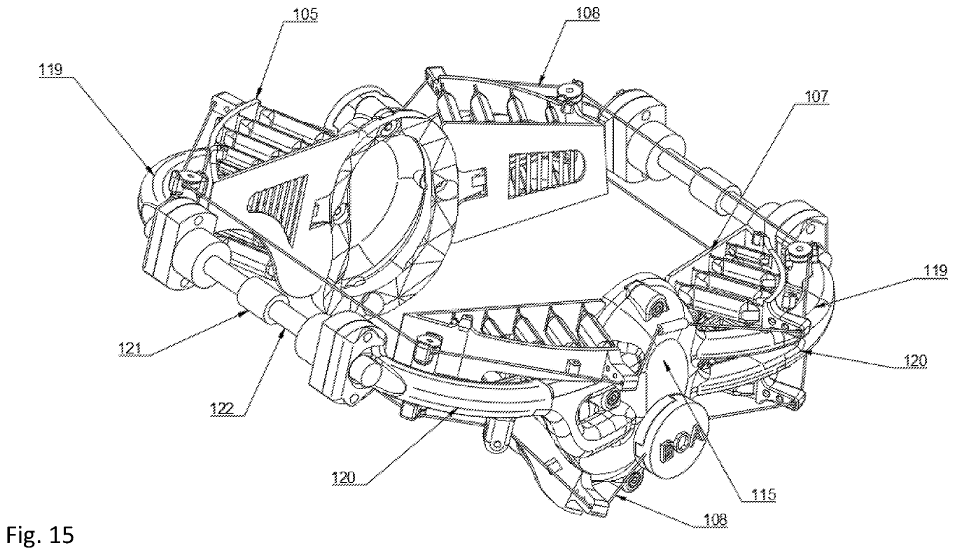

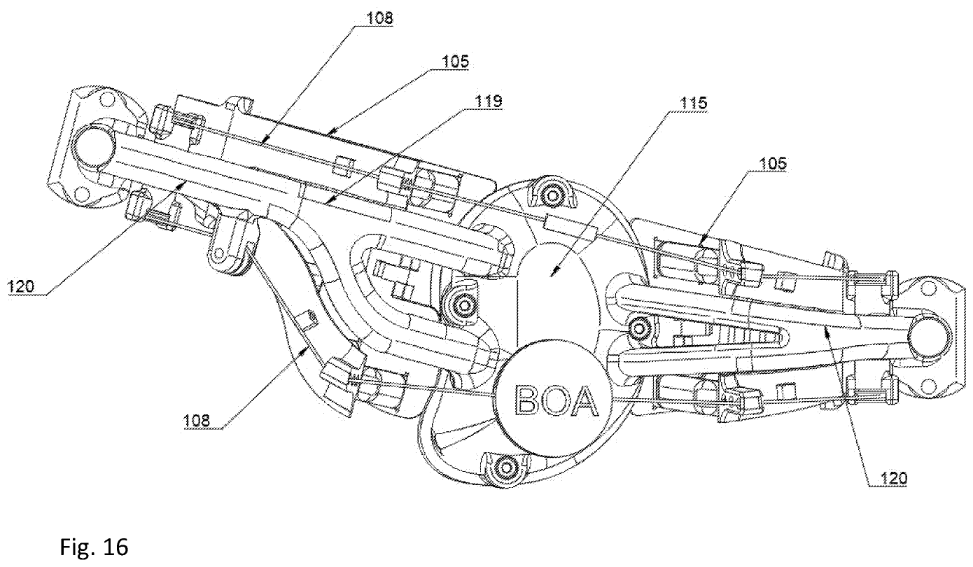

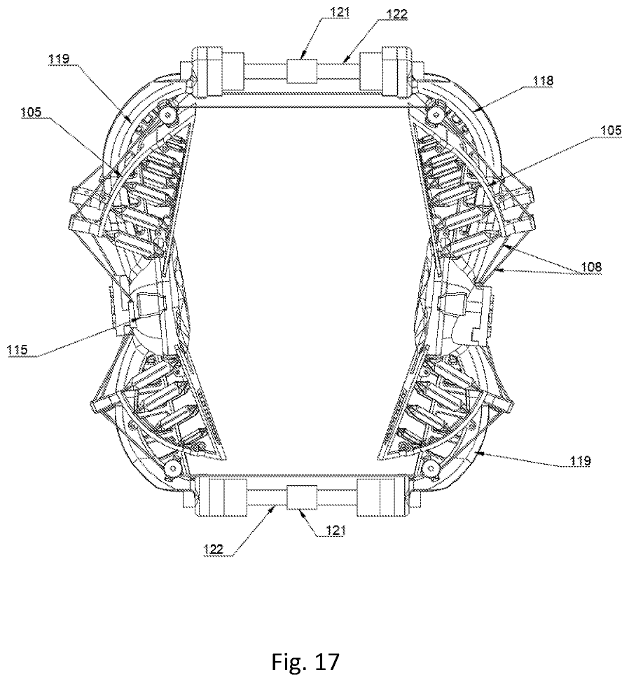

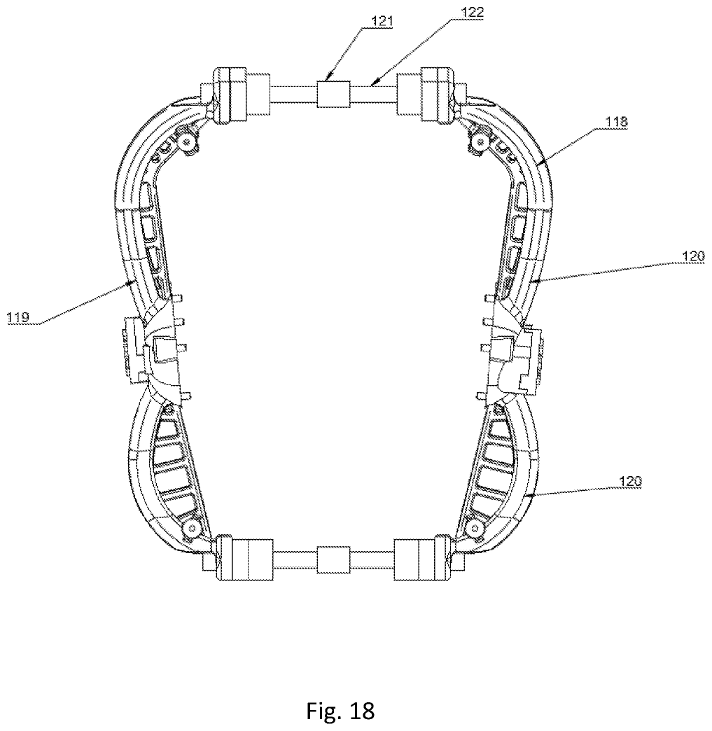

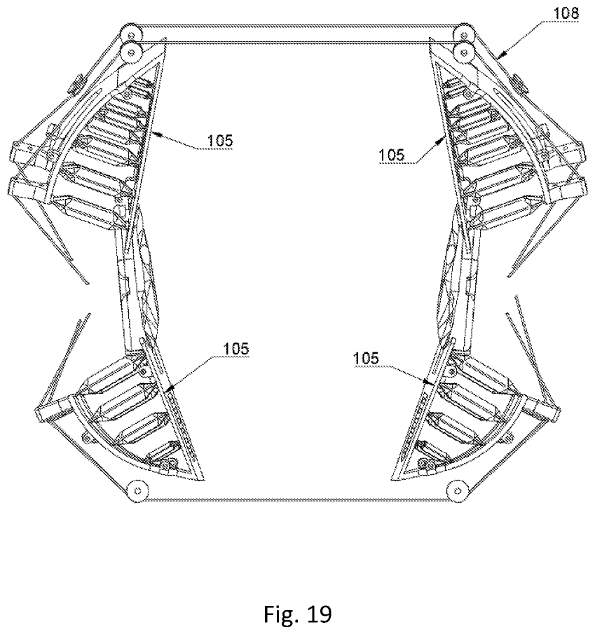

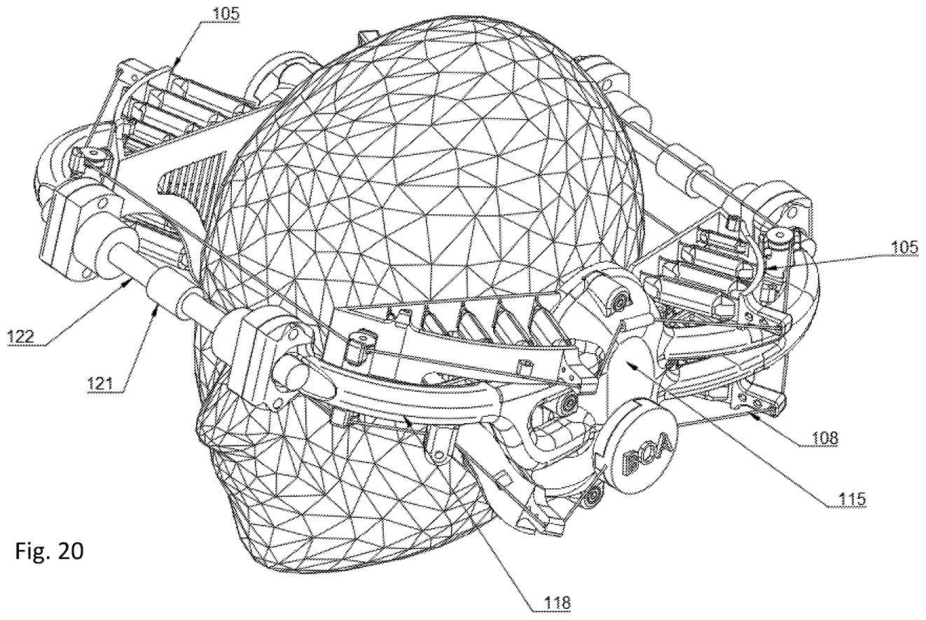

Shown in FIGS. 15 to 20 is an example of the device 100 for supporting a head, which has a rigid outer element 118 that serves to guide the BOA cable, in particular, and prevents its contact with the head. The rigid outer element 118 includes two curved rods 119, which are connected to one another at their free ends so as to be adjustable in length, wherein each curved rod 119 can be composed of two sub-rods 120 whose ends that face one another are associated with one of the ear cups 115. The adjustable-length connection of the free ends is formed at least at one pair of the free ends, concretely at both pairs of the free ends, by a threaded rod 122 with opposite-direction threads at its ends, which engage with the free ends in a spindling manner in threaded receptacles having a corresponding thread direction. The kinematic reversal with a threaded sleeve 121 with a different thread direction in its threaded receptacles, in which the free ends of threaded rods 122 engage, is likewise possible.

A structural body or a navigation star 123 can be associated with the device 100 for supporting a head, which body can be connected in one piece to the device 100, or preferably can be permanently or detachably coupled, which is to say connected, to the device 100 via a coupling element 104. The rigid outer element 118 in this case is suitable, in particular, as a carrier of the navigation star 123, as are the ear cups 115, since the position of the head and any position changes can be accurately detected. In like manner, the device can be or become permanently connected to an operating table or a table in a CT or MRI device.

It is noted only for the sake of completeness that the rigid outer element 118 can also be used with any of the examples and, more generally, it is possible and desirable for individual features explained on the basis of an example to also be combinable with the features of other examples.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device to support a head of a person, the device comprising:
at least two lips that are placed around a first main axis and around a second main axis oriented substantially perpendicular to the first main axis, the at least two lips form, together with at least one securing system, a closed curve with a hollow space formed therein for supporting the person's head, wherein the securing system is designed, by matching a circumference of the curve, to form a homogeneously acting positive engagement or frictional engagement between the lips and the person's head.

2. The device according to claim 1, further comprising at least one coupling element to couple to a structural body and/or to a training apparatus.

3. The device according to claim 1, wherein the closed curve forms an ellipse, wherein a deviation of a length of the first and second main axes from one another corresponds to less than 25%, or less than 15%, or less than 10%, or less than 5%.

4. The device according to claim 1, wherein the securing system has at least one tension and/or compression component to adjust the circumference of the closed curve, and wherein a change in the circumference of the closed curve brought about by the tension and/or compression component causes an application of force to the lips.

5. The device according to claim 4, wherein at least two curved rods, which are connected to one another at their free ends so as to be adjustable in length, are associated with the securing system.

6. The device according to claim 5, wherein the connection is formed, at least at one pair of the free ends, by a threaded rod with opposite-direction threads at its ends, which engage in a spindling manner with free ends in threaded receptacles having a corresponding thread direction, or wherein a telescoping connection is formed.

7. The device according to claim 1, wherein the lips are grippers that are connected to the securing system, wherein the grippers each have two curved, mutually converging, outer sidewalls that are connected to one another via struts and that are in operative connection with one another such that a force exerted on at least one of the outer sidewalls in a direction of force causes a deflection of the gripper opposite the direction of force to create a positive engagement between the grippers and the person's head.

8. The device according to claim 7, wherein, to connect the grippers to the securing system, the gripper comprises, on an external outer sidewall, a guide tube or a pulley in which the securing system is guided.

9. The device according to claim 7, wherein the grippers are arranged opposite one another and are connected to the securing system for contact of a first gripper on a forehead of the head and of a second gripper on a back of the head above the external occipital protuberance.

10. The device according to claim 9, wherein at least one of the grippers is composed of a plurality of subgrippers, wherein two of the subgrippers are connected to one another via at least one flexible connecting strut.

11. The device according to claim 1, wherein the lips are formed in a wave shape formed of a minimum of one wave crest and one wave trough, and wherein at least one of the wave crests is connected to the securing system.

12. The device according to claim 2, wherein the lip in a region of the coupling element have a first thickness, and wherein the lip in the region adjacent to the coupling element has a second thickness, and wherein the second thickness is smaller than the first thickness.

13. The device according to claim 1, wherein an ear cup is provided for surrounding an associated ear.

14. The device according to claim 13, further comprising a curved rod that is formed of two sub-rods whose ends that face one another are associated with the ear cup.

15. The device according to claim 14, wherein the coupling element is formed on the ear cup or on the sub-rods.

16. The device according to claim 1, further comprising a navigation star or a securing table.

17. A combination of a training apparatus and the device according to claim 2 to support a head, wherein the device is adapted to be coupled to the training apparatus via the coupling elements.

18. The combination according to claim 17, wherein the coupling elements are formed as an ear cup, and wherein the training apparatus is adapted to be coupled to the ear cups via a connecting element such that a coupling axis running along the connecting elements approximately coincides with an auditory canal axis running between the auditory canals.
